(19) United States
(12) Patent Application Publication
(10) Pub. No.: US 2026/0199822 A1
(43) Pub. Date: Jul. 16, 2026

(54) GAS TREATMENT APPARATUS AND GAS TREATMENT METHOD

(71) Applicants: China Petroleum & Chemical Corporation, Beijing (CN); Sinopec Engineering (Group) Co., Ltd., Beijing (CN)

(72) Inventors: Qiang CHEN, Luoyang, Henan (CN); Jia WEI, Luoyang, Henan (CN); Weiwu SHENG, Luoyang, Henan (CN); Xiaoting LI, Luoyang, Henan (CN); Yongpan CHENG, Luoyang, Henan (CN); Linge LI, Luoyang, Henan (CN)

(73) Assignees: China Petroleum & Chemical Corporation, Beijing (CN); Sinopec Engineering (Group) Co., Ltd., Beijing (CN)

(21) Appl. No.: 19/137,489

(22) PCT Filed: Dec. 21, 2023
(86) PCT No.: PCT/CN2023/140737

§ 371 Date: Jun. 10, 2025

(30) Foreign Application Priority Data
Mar. 8, 2023 (CN) 202310216131.2
Mar. 8, 2023 (CN) 202310216392.4
Mar. 8, 2023 (CN) 202310216418.5

(51) Int. Cl. B01D 53/18; B01D 53/14; B01D 53/52; B01D 53/79; B01F 23/231; B01F 23/232; B01F 25/312; B01F 35/00; B01F 101/00

(52) U.S. Cl. CPC B01D 53/185; B01D 53/1468; B01D 53/52; B01D 53/79; B01F 23/23105; B01F 23/2321; B01F 25/3121; B01F 35/55; B01D 2257/304; B01F 2101/2204

(57) ABSTRACT

The gas treatment apparatus includes: a column, an upper sealing head connected to an upper end of the column, and a lower sealing head connected to a lower end of the column, wherein: a fluid inlet pipe is arranged at a position of the column close to the upper scaling head, a fluid outlet end of the fluid inlet pipe extending into the column, and the fluid outlet end being connected to an absorption fluid spray nozzle used for spraying absorption fluid downwards; a gas inlet pipe is arranged at a position of the column close to the lower scaling head, and a gas outlet end of the gas inlet pipe extends into the column; the gas outlet end of the gas inlet pipe has connected thereto a microbubble-generating inner part; a back-mixing inner part is arranged in the column above the microbubble-generating inner part.

### TECHNICAL FIELD

The present invention is the field of gas hybrid and mass transfer technology, which involves a dual-decentralized liquid transmission device.

### BACKGROUND TECHNIQUE

As an important quality and separation equipment in the tower, it is widely used in oil, chemical, medicine and other fields, such as distillation, gas purification, and absorption requires the participation of tower equipment., Product quality, energy conservation and emission reduction and many other links.

At present, related research is mainly concentrated in the optimization and applicable development of the inner part of the tower plate, and less involves streaming types. This is because the method of liquid liquid contact is mainly three types: wrong, inverse flow, and side-by-side, and the error flow tower plate has the advantages of large operating elasticity, stable operation, and large volume of gas liquid compared to the other two streamlined tower plates. Traditional error flow contact tower such as bubbles, floating valves, and sieve plates has the characteristics of large gas liquid flux, simple structure, and large operating elasticity. On the wrong flow tower plate, a certain liquid level difference is required when the liquid phase crosses the tower plate, which will cause uneven distribution of gas and liquid, affecting the quality of the quality. As the equipment is gradually large, the gas liquid in the tower plate is on the tower plate. The radial distribution on the top will become increasingly uneven, which seriously affects the efficiency of the tower. And on the tower, the gas is used as a dispersion to pass through the liquid on the plate. The size of the bubbles is large, the bubbles are rising fast, the air fluid contact time is short, and the quality is not high.

Reducing the diameter of bubbles and improving the contact time of gas and liquid can effectively improve the efficiency of air liquid contact time and gas fluid transmission. Patent 201521107453.0 revealed a kind of micro-bubble tower plate plate gas liquid transmission tower. By installing a sieve net on the sieve plate, the air bubbles on the tower are installed to increase the air-liquid-free area and increase the time of contact with the liquid liquid Efficiency, reducing tower height, but not solving the problem of uneven radial distribution in the tower plate liquid. Patent 200710055816.4 Displained a high-efficiency gas-liquid passing device. The gas phase was broken through the bubble distribution device, but it still reduced the size of the bubbles through the method of perforation. There is a hydraulic pipe between the liquid exchange mechanism, which causes the high level of effective quality in the tower; in addition, the structural combination of the baffle, the downside tube and the exhaust holes will cause the device Caused or even stopped in the tower.

The spray tower has the advantages of simple structure, not easy to block, and small gas resistance. It is commonly used in the field of absorption and washing in easy crystallization and blocked, especially in the field of smoke and desulfurization. The mass transmission process of the two phases in the spray tower occurs on the surface of the droplet, that is, the liquid phase is used as a decentralized phase, and the gas is continuous. Compared with the decentralization of the gas phase, the decentralization of the liquid phase can better reduce the particle size of the dispersion phase, increase the increase of the size of the phase, increase Large contact area.

In the spray tower, the droplets also have a speed of moving towards the wall of the tower when moving downward. After the landing is landing, it will contact the tower wall and flow down along the wall to reduce the area of the gas liquid contact area and cause uneven liquid distribution of the liquid phase. The effect of gas liquid contact effect is affected. Set the liquid collection liquid and spray the liquid again. The form of multi-layer spray can effectively increase the contact area of the heavier liquid, strengthen the speed of the surface update of the liquid phase, and promote the quality of the gas liquid contact.

### INVENTION CONTENT

In response to the lack of existing technology, the purpose of the present invention is to provide a dual-decentralized liquid transmission device. This device uses a combination of liquid phase dispersion and gas dispersing to form a dual-decentralized gas dispersed and upper liquid-phase dispersion. The liquid transmission device can effectively increase the area of the air liquid contact area and increase the contact time of the gas liquid, thereby strengthening the gas liquid transmission.

In order to achieve the above goals, the present invention provides the following technical solutions:

A dual-decentralized liquid transmission device, including the tower body, has an air outlet at the upper end of the tower body, and the lower end is equipped with liquid exports; Entrance; the first round, upper-layer anti-vortex grille, and the first nozzle are set up from bottom to top to top; The air intake holes in the disk are connected to the entrance of the gas in the pipeline; the upper-layer anti-vortex grille is located under the liquid interface, and the first nozzle is located on the liquid interface.

Preferably, the first fixed structure is provided above the first round, which is the first motor above the fixed structure above the first fixed structure. The upper baffle of the plate is fixed.

Preferably, the first round includes the upper baffle and the lower baffle, the upper baffle is a circular plate, which is a porous round board; the edge of the upper baffle and the lower baffle There are porous sieve plates at a fixed connection; the intake pores are located in the center of the lower baffle, with multiple inlet holes on the outside of the pores; The cavity is also equipped with fillers.

Preferably, there is a lower-layer anti-vortex grille under the first round; there is a wire mesh removal above the first nozzle.

Preferably, there is a gas dispersed device between the first motor and the upper-layer anti-vortex grille; there is a liquid-phase decentralized device between the first nozzle and the liquid phase interface.

Preferably, the liquid-phase decentralized device includes liquid box, liquid pump, and a second spray head, which is below the first nozzle of the liquid box, which is below the liquid box; The solution pump is connected to the second nozzle with the liquid box and the second nozzle through the pipeline.

Preferably, the air-phase decentralized device includes the gas mask, the second round, the second fixed structure, and the second motor. The upper and upper holes are connected with the airmaker; the second fixed structure is located above the second round, and the second motor is connected above the second fixed structure. The second fixed structure is connected to the upper baffle of the second round.

Preferably, the qi phase decentralized device and the liquid-phase dispersed device are set up at least one group.

Compared with existing technology, the present invention has the following useful effects:
(1) The dual-decentralized liquid transmission device provided by the present invention, the qi liquid interface is updated quickly, the quality of the mass transmission is large, the contact time is long, and the quality of the quality is good. The liquid phase flows from top to bottom in the tower, the gas phase flows from the bottom to the tower, and the gas liquid overall flows. In the upper part of the tower, the liquid phase is sprayed to form a large amount of small droplets, which is used as a dispersion phase to contact with the gas phase. In the lower part of the tower, the gas phase is crushed into a large amount of micro-foaming through the wheel disk. As a decentralized phase and liquid-phase contact, it greatly improves the driving force and enhanced contact with the quality of the contact. The surface is updated, and at the same time, the increase of the liquid is compared to the surface area; multiple cutting and crushing of the gas phase is conducive to the surface renewal of the gas phase. The method of crushing of gas phase to form a dual-decentralized liquid contact form, which can significantly increase the area of the gas liquid transmission quality and the contact time of the gas liquid, and the gas liquid interface is updated quickly, which is conducive to strengthening the gas liquid transmission quality.
(2) High use of tower section. Compared with the plate-type tower, there is no reduction liquid disk and a liquid disk structure, which increases the use of tower section. At the same time, the gas liquid is evenly distributed on the tower section, which can also increase the tower section utilization rate.
(3) The height of the equipment is reduced and the materials consume less. Because the quality of the gas fluid is good, it can greatly reduce the tower height, thereby reducing material consumption.
(4) Suitable for a solid particle system. The wheel disk is rotated at a high speed, the solid particles cannot stay inside, it will not cause the wheel disk to block, and there is no other component of the solid particles that accumulate solid particles in the tower.

### ATTACHMENT DESCRIPTION

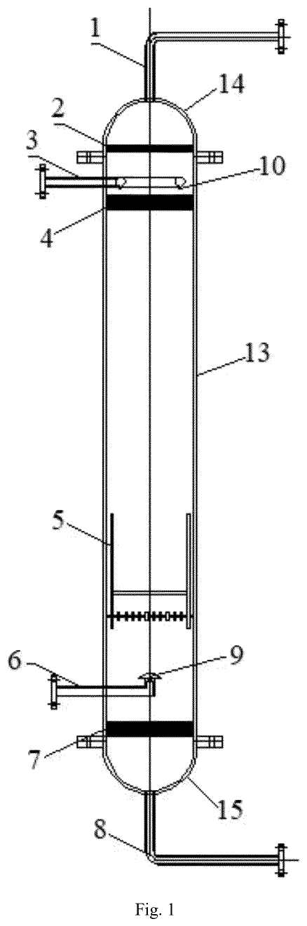

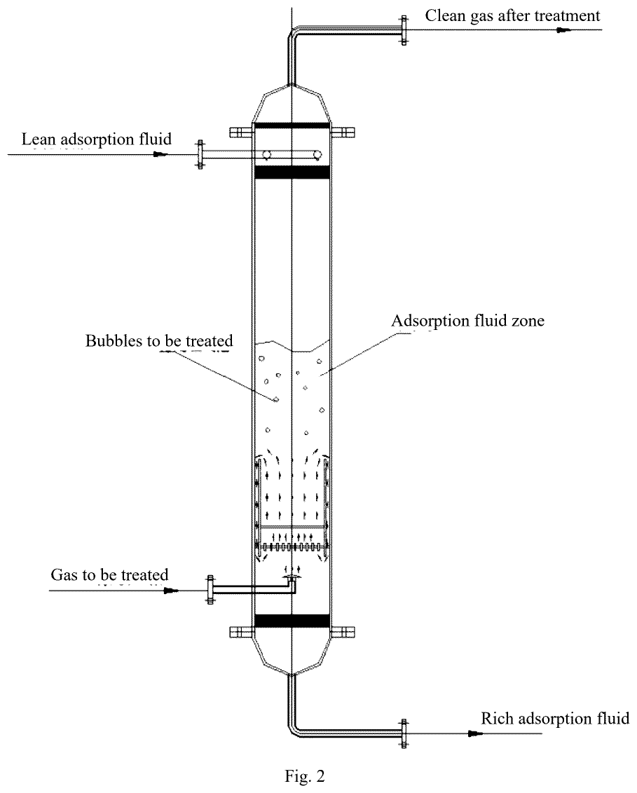

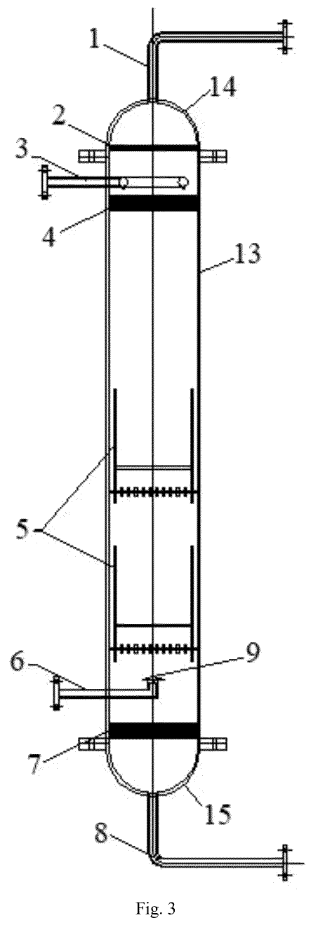

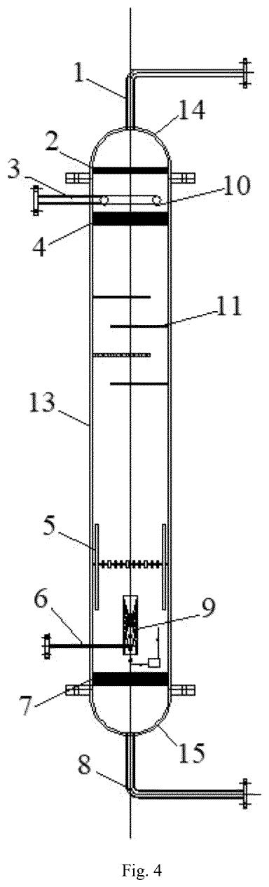

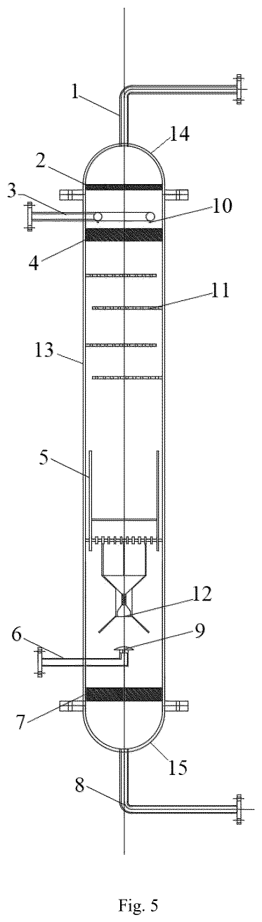

FIG. 1 It is a schematic diagram of the dual-decentralized liquid transmission device of the present invention;

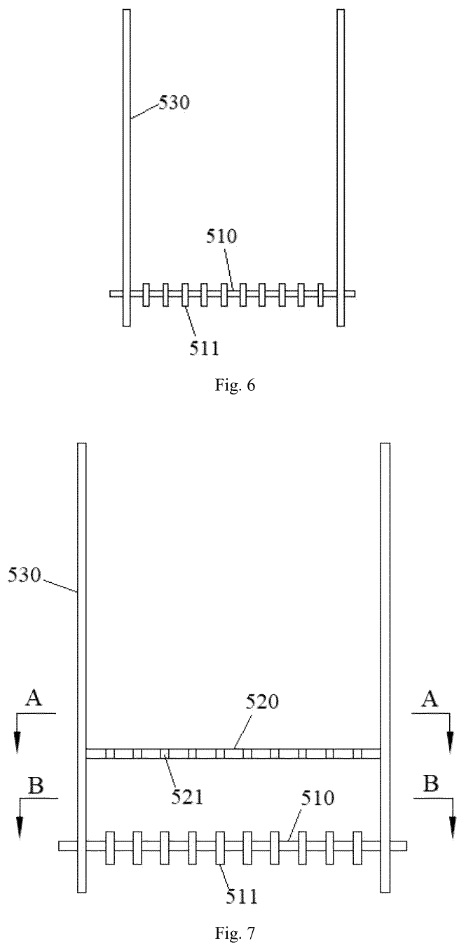

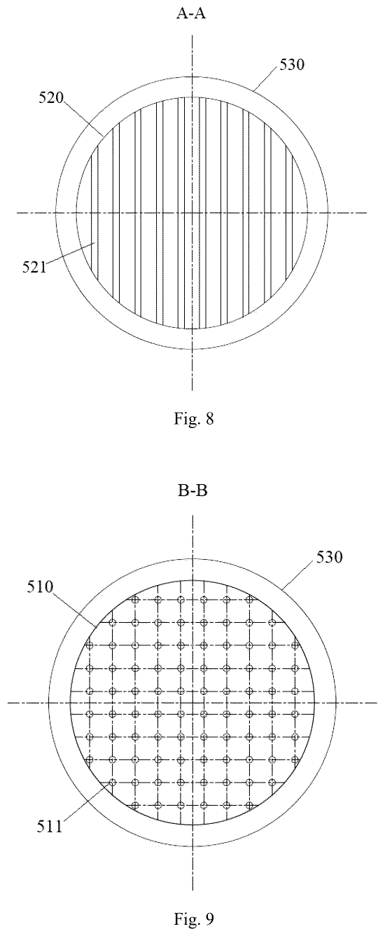

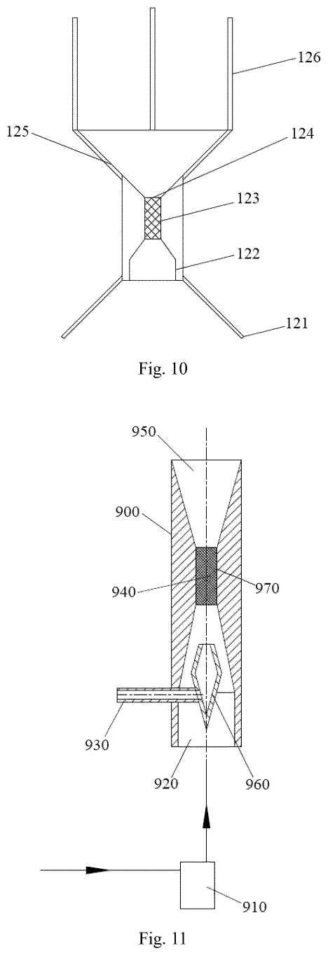

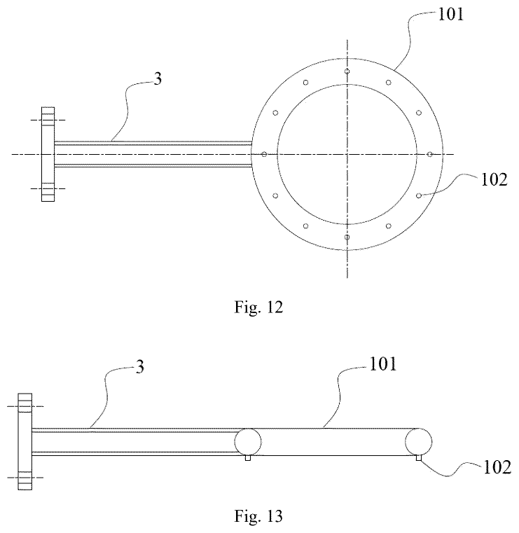

FIG. 2 It is a structure diagram of the wheel disk of the present invention.

Among them, 1, tower body; 2. liquid portal entrance; 3. first spray head; 4. liquid interface; 5, first round set; 6, first fixed structure; 7, first motor; 8, gas phase entry; 9, lower-level anti-vortex grille; 10, liquid phase exit; 11, air masks; 12, second round; 13, second fixed structure; 14, second motor; 15, upper layer anti-vortex grille; 16, first Two nozzles; 17, liquid phase pump; 18, liquid set; 19, wire mesh removal; 20, gas phase exit; 51, lower baffle; 52, upper baffle; 53, porous sieve board; 55, intake holes.

### DETAILED WAYS

In order to make the purpose, technical solution and advantages of the embodiments of the present invention more clear, the following will be combined with the attached figures in the embodiments of the present invention to clearly and complete the technical scheme in the embodiments of the present invention. It is a part of the embodiments of the present invention, not all of the embodiments. The components of the embodiments described and shown in the drawing here are usually arranged and designed by various configurations.

Therefore, the detailed description of the embodiments of the present invention provided in the attachment below does not mean to limit the scope of the present invention that requires protection, but only the selection embodiment of the invention. Based on the embodiments in the present invention, all other embodiments obtained by ordinary technical personnel in the art under the premise of not creating creative labor belong to the protection of the present invention.

It should be noted that the similar label and the letter represent the similar item in the attached figure below. Therefore, once a certain item is defined in a picture, it does not need to be further defined and explained in the subsequent attachment.

In the description of the present invention, it should be explained that if the term or position relationship of the instructions of the term “up”, “lower”, “inner”, “outside” is based on the position or location of the attached picture, or the position, or It is the orientation or position that the invention is used in the use, just to facilitate describing the present invention and simplified description, rather than indicating or implying that the device or component that the referred to in the indication must have a specific orientation, construct and operation in a specific orientation, and operation. Therefore, it cannot be understood as restrictions on the present invention.

In addition, if the term “first” and “second” are used to distinguish the description, it cannot be understood as the instructions or the relative importance.

It should be noted that the characteristics of the embodiments of the present invention can be combined with each other without conflict.

See FIG. 1, A dual-decentralized liquid transmission device, including tower body 1, which has gas export 20 at the upper end of the tower body 1, and the lower end has liquid export 10; 2. There is a gas phase entrance at the bottom of the side; the internal tower body 1 is set up from the bottom to the top 5, the upper-layer anti-vortex grille 15 and the first nozzle 3; The liquid phase entrance 2 is connected, and the inlet pore 55 in the first round 55 is connected to the gas phase entrance 8 through the pipeline; The first nozzle head 3 is located on the liquid interface 4.

Preferably, the first fixed structure 6 is provided above the first round 5. The first fixed structure 6 is connected to the first motor 7 above. Structure 6 is fixed with the upper baffle 52 of the first round 5.

See FIG. 2 The first round 5 includes upper baffle 52 and lower baffle 51, which is the upper baffle 52 is a circular plate, which is the porous round plate of the lower baffle 51; The edge 51 is fixed at the edge of the porous sieve 54; the inlet pore 55 is located in the center of the lower baffle 51. Board 52, porous sieve 54, and lower baffle 51 are also equipped with filler 53.

Preferably, the type of filler 53 is not limited, and it can be porous honeycomb fillers or grille fillers.

Specifically, the first round is immersed in the liquid phase. Driven by the first motor, the gas phase rotates at a high speed. The gas phase enters the first round through the intake hole and is cut into countless fine air bubbles by the filler in the first round. A round of porous sieve plates is sprayed on the side of the plate, mixed with the liquid phase, and moved upward to complete the gas-liquid transmission.

Specifically, the use of wheel bubbles with wheel disk has the following advantages:
1. Small bubble particle size. Due to the high-speed rotation of the wheel disk, the air bubbles are cut into a micron-level air bubble by the fillers in the wheel disk.
2. Low pressure drop. On the traditional tower, the air bubbles need to overcome the resistance, the existence of gas drop, and the pressure drop increases sharply with the decrease of the aperture.
3. Can handle the solid particle system. Due to the high-speed rotation of the wheel disk, the solid particles cannot stay inside it, which will not cause the wheel disk to block.

Continue to see FIG. 1 In the first round 5, there is a lower layer of anti-vortex grille 9; the first spray head 3 has a wire mesh removal 19.

Specifically, the lower anti-vortex grille 9 above the first round 5 and the upper upper-level anti-vortex grille 15 is to prevent the rotation of the wheel disk to form a vortex.

Preferably, the first motor 7 and the upper-layer anti-vortex grille 15 have a divergent device of gas; the first nozzle head 3 and the liquid interface 4 have a liquid-phase device.

Preferably, the liquid-phase decentralized device includes liquid box 18, liquid phase pump 17, and second noble header 16. The liquid box 18 is below the first nozzle head 3, which is located in the second nozzle head 16 is located in the description of the second nozzle head 16. The liquid box is below 18; the liquid phase pump 17 is connected to the pipeline with the liquid box 18 and the second nozzle 16.

Specifically, the liquid phase enters the tower body 1 from the liquid phase entrance 2, spray it into a large amount of small droplets through the first sprays, and falls into the liquid box 18 in the liquid phase decentralized device. After the pipeline passed the pipeline, the liquid phase pump 17 was pulled out and the tower body 1 was once again hit, and then the second sprays 16 were sprayed again to form a large amount of fine droplets., Eventually, from the exit of the liquid phase 10.

Preferably, the air-phase decentralized device includes air masks 11, the second round 12, the second fixed structure 13, and the second motor 14. The gas mask 11 is above the first motor 7, the second round The plate 12 is located above the airmaker 11 and connects to the air mask 11 through the pores 55; the second fixed structure 13 is above the second round 12, which is the fixed connection above the second fixed structure 13. The second motor 14, the rotation axis of the second motor 14 passed through the second fixed structure 13 and the upper shield fixed connection of the second round 12.

Specifically, the gas phase enters the first round 5 in the tower body 1 from the gas phase entrance 8. Under the high-speed rotation of the first round 5, the gas phase is cut and crushed by the fillers. A large amount of micro-air bubbles are formed in the continuous phase of the liquid orientation. The second round 12 was cut and crushed again, further passed the quality with the liquid orientation, and finally passed through the liquid interface 4 to enter the gas on the top of the tower body 1 continuously. discharge.

Preferably, the first round 5 is the opposite of the rotation direction of the second round 12.

Specifically, in order to prevent the rotation of the rotation of the rotation of the liquid phase, the rotation direction of the adjacent wheel disk is opposite to offset some vortex energy.

Preferably, the qi phase decentralized device and the liquid-phase dispersed device are set up at least one group.

### Example 1

A dual-decentralized liquid transmission device, including Tower body 1, has gas export 20 at the upper end of the tower body 1, and the lower end has liquid export 10; There are 8 gas port entrances below the side; the inside of the tower body 1 is set up from the bottom to the top 5, the upper-layer anti-vortex grille 15 and the first nozzle 3; The liquid phase entrance 2 is connected, which is connected to the gas phase entrance 8 through the pipeline 55 in the first round 5; The first nozzle is located above the liquid interface 4.

In this embodiment, the first fixed structure 6 is provided above the first round 5, which is the first motor 7 above the fixed connection of the first fixed structure 6. The first fixed structure 6 is connected to the upper baffle 52 of the first round 5.

In this embodiment, the first round 5 includes the upper baffle 52 and the lower baffle 51, which is a round board 52, which is There is a porous sieve 54 at a fixed connection between the baffle 52 and the lower baffle 51; the inlet pore 55 is located in the round heart of the lower baffle 51. ; The upper baffle 52, porous sieve 54, and lower baffle 51 are also equipped with filler 53.

In this embodiment, the filler 53 is a porous honeycomb filler, which distributes a large number of small holes on the porous honeycomb fillers, with an opening rate of 45.7%.

In this embodiment, there is a lower-layer anti-vortex grille 9 below the first round 5; the first spray head 3 has a wire mesh removal 19.

In this embodiment, there is a gas phase decentralized device between the first motor 7 and the upper layer anti-vortex grille 15; Essence

In this embodiment, the liquid-phase decentralized device includes liquid box 18, liquid phase pump 17, and second noble header 16. The liquid box 18 is below the first nozzle head 3, the second spray head 16 16 Located below the liquid box 18; the liquid phase pump 17 is connected to the pipeline with the pipeline of the set liquid box 18 and the second spray head 16.

In this embodiment, the air-phase decentralized device includes gas masks 11, second round 12, second fixed structure 13, and second motor 14. The airmaker 11 is above the first motor 7, which is mentioned. The second round 12 is located above the airmaker 11 and connects to the air mask 11 through the pilot 55; the second fixed structure 13 is above the second round 12, the second fixed structure 13 above 13 There is a second motor 14 in a fixed connection. The rotation of the second motor 14 through the second fixed structure 13 is fixed with the upper baffle of the second round 12.

In this embodiment, the first round 5 is opposite to the rotation direction of the second round 12.

In this embodiment, the gas-phase decentralized device and the liquid phase decentralized device are set up.

The specific work process of the double-separation gas fluid transmission device of the present invention is as follows:

At the upper part of the tower body, the liquid phase enters the tower body 1 from the liquid port 2, and the first spray head 3 spray to form a large amount of fine droplets. For part of the mass, part of the liquid box 18, and the liquid phase in the liquid box 18 was pulled out by the liquid phase pump 17 and the tower body 1 was once again. In contact with the gas phase countercurrent contact, finally fall into the liquid interface 4, the dispersing phase from the upper part of the tower body 1 to the continuous phase of the lower part of the tower body 1, and exercise continuously in the lower part of the tower body 1, and finally export from the liquid phase exit 8 discharge.

At the lower part of the tower body, the gas phase enters the first round 5 from the gas phase entrance 8 to the first round 5 in the tower body. Under the high-speed rotation of the first round 5, the filler 53 is cut and crushed. Spray outward, form a large amount of micro-bubbles in the liquid phase to further contact the gas liquid, move the micro-bubble at a certain speed, and some air bubbles enter the airmaker 11 in the air. The gas phase entered the second round 12 was cut and crushed again to form a large amount of micro-bubbles. At the same time, the gas phase interface was updated. After spraying from the porous screen board 54 of the second round 12, it was further exposed to the quality and moved up. The liquid interface 4 enters the air on the top of the tower body continuously, and further forms the air fluid inverse contact with the small droplets of the decentralized phase, further pass the quality, and eventually passes through the wire mesh removal 16, and the export of gas exits 15.

At the same time, in order to prevent the rotation of the wheel disk to drive the liquid phase to form a vortex, there is a lower-level anti-vortex grille 9 below the first round 5, and the upper layer anti-vortex grille 15 is provided above the second round 12. At the same time, it is adjacent. The rotation direction of the wheel disk is opposite to offset some of the vortex energy, and it can effectively remove the droplet in the gas phase by setting the wire removal device 19.

In addition, when the first round 5 was rotated at a high speed, because the lower baffle 51 was opened with intake pores 55 and inlet pores, the gas phase entered from the pipeline of the tower through the pipeline of the pipe, and the liquid phase entered from the inlet hole. In the first round of the 5-cavity, the two-phase gas liquid and the two phases of the gas liquid were fully mixed with contact with the quality, and the cutting of the gas phase was completed. The liquid phase entered the cavity from the lower baffle 51 of the first round 5, from the side 5 of the first round 5 The porous screen 54 is discharged.

Although the embodiments of the present invention have been shown and described, for ordinary technical personnel in the art, it is possible to understand that these embodiments can be performed without the principle and spirit of the present invention. The scope of the present invention is limited by the claims and equivalences.

1. A gas treatment apparatus, comprising a cylinder, a top sealing head connected to a top end of the cylinder, and a bottom sealing head connected to a bottom end of the cylinder, wherein:
a fluid inlet pipe is arranged at a position of the cylinder close to the top sealing head a fluid outlet end of the fluid inlet pipe extends into the cylinder, and the fluid outlet end is connected to an absorption fluid sprayer used for spraying absorption fluid downwards;
a gas inlet pipe is arranged at a position of the cylinder close to the bottom sealing head, and a gas outlet end of the gas inlet pipe extends into the cylinder and is used for inputting a gas to be treated into the cylinder;
the gas outlet end of the gas inlet pipe has a microbubble-generating inner part connected thereto, and the microbubble-generating inner part is used for forming microbubbles from the gas to be treated coming from the gas outlet end, and for mixing the microbubbles into the absorption fluid;
a back-mixing inner part is arranged in the cylinder above the microbubble-generating inner part, and the back-mixing inner part is used for causing the absorption fluid to form a back-mixing vortex under the action of an upward flow of the microbubbles.

2. The gas treatment apparatus of claim 1, wherein the microbubble-generating inner part comprises an inner part body and a submerged pump, wherein the inner part body comprises a first variable-diameter mixing cavity, a reduced mounting cavity and a second variable-diameter mixing cavity, which are in communication with each other sequentially from bottom to top; an end of the first variable-diameter mixing cavity away from the reduced mounting cavity forms a liquid phase inlet, the first variable-diameter mixing cavity has a conical cavity therein, and an end of the conical cavity facing the reduced mounting cavity is open; the reduced mounting cavity is filled with a first mixing core; the inner part body further comprises an gas inlet branch pipe, one end of the gas inlet branch pipe is connected to the gas outlet end of the gas inlet pipe and the other end of the gas inlet branch pipe is in communication with the conical cavity; and an outlet of the submerged pump is in communication with the liquid phase inlet.

3. The gas treatment apparatus of claim 2, wherein an end of the first variable-diameter mixing cavity connected with the reduced mounting cavity and an end of the second variable-diameter mixing cavity connected with the reduced mounting cavity are small-diameter ends.

4. The gas treatment apparatus of claim 3, wherein the first variable-diameter mixing cavity comprises a cylindrical section and a conical section, which are in communication with each other from bottom to top, and a maximum diameter of the conical section is equal to the diameter of the cylindrical section; the diameter of the reduced mounting cavity is equal to a minimum diameter of the conical section, the second variable-diameter mixing cavity is configured to gradually expand from bottom to top, and a minimum diameter of the second variable-diameter mixing cavity is equal to the diameter of the reduced mounting cavity.

5. The gas treatment apparatus of claim 4, wherein the conical cavity comprises a first conical section and a second conical section, which are in communication with each other from bottom to top, and the gas inlet branch pipe is in communication with the first conical section;
optionally, the conicity of the first conical section is greater than the conicity of the second conical section.

6. The gas treatment apparatus of claim 1, wherein a Venturi mixing inner part is arranged in the cylinder between the microbubble-generating inner part and the back-mixing inner part, and the Venturi mixing inner part is used for further breaking a microbubble stream from the microbubble-generating inner part, accelerating the microbubble stream and then outputting the microbubble stream upwards.

7. The gas treatment apparatus of claim 6, wherein the Venturi mixing inner part comprises a gas collection port a cavity structure and a mixing expansion port, which are connected sequentially from bottom to top, wherein the gas collection port is configured to be reduced gradually in diameter from bottom to top; the mixing expansion port is configured to be gradually expanded in diameter from bottom to top; the cavity structure has a reduced section in communication with the bottom of the mixing expansion port and a variable-diameter section in communication with the bottom of the reduced section therein, and the reduced section is filled with a second mixing core;
optionally the Venturi mixing inner part further comprises a connecting leg, which is connected between the top of the mixing expansion port and the bottom of the back-mixing inner part.

8. The gas treatment apparatus of claim 1, wherein the back-mixing inner part comprises an inner cylinder and a distribution disc mounted on an inner wall of the inner cylinder, wherein the inner cylinder is coaxially arranged with the cylinder, with clearance between an outer wall of the inner cylinder and the inner wall of the cylinder, and/or
a gas exhaust pipe is arranged on an upper part of the top sealing head, and a drain pipe is arranged on a lower part of the bottom sealing head.

9. The gas treatment apparatus of claim 8, wherein the inner cylinder is in height of 500-1,500 mm, and the clearance between the outer wall of the inner cylinder and the inner wall of the cylinder is 100-200 mm; and/or
the back-mixing inner part further comprises a sieve plate mounted on the inner wall of the inner cylinder, and the sieve plate is arranged above the distribution disc in a spaced apart manner.

10. The gas treatment apparatus of claim 9, wherein the distribution disc is provided with a plurality of axial through-holes, and a tubular distributor is arranged in each axial through-hole; and/or a plurality of bar gratings are arranged on the sieve plate.

11. The gas treatment apparatus of claim 1, wherein a deflection baffle is arranged on the inner wall of the cylinder between the back-mixing inner part and the fluid inlet pipe, and/or a defoaming mechanism is arranged on the inner wall of the cylinder.

12. The gas treatment apparatus of claim 11, wherein the defoaming mechanism comprises an upper defoamer, a middle defoamer and a lower defoamer, wherein the upper defoamer is located above the fluid inlet pipe, the middle defoamer is located between the fluid inlet pipe and the deflection baffle, and the lower defoamer is located below the gas inlet pipe.

13. The gas treatment apparatus of claim 12, wherein all of the upper defoamer, the middle defoamer and the lower defoamer are wire mesh structures,
the upper defoamer has 1-5 mm mesh aperture, 0.5-2 mm wire diameter, and 50-100 mm thickness;
the middle defoamer has 1-5 mm mesh aperture, 0.5-2 mm wire diameter, and 100-200 mm thickness; and
the lower defoamer has 2-8 mm mesh aperture, 0.5-2 mm wire diameter, and 100-200 mm thickness.

14. A gas treatment method, comprising the following steps:
S1: introducing a gas to be treated into an absorption fluid zone in the form of microbubbles for primary reaction;
S2: controlling the absorption fluid in the absorption fluid zone to form a back-mixing vortex under the action of a microbubble stream flowing upwards;
S3: spraying the absorption fluid downwards above the absorption fluid zone, so that the gas escaping from the absorption fluid zone has a secondary reaction with the absorption fluid sprayed downwards in an upward flowing process.

15. The gas treatment method of claim 14, further comprising: further breaking the microbubble stream and accelerating it before the step S2; and/or
the method is implemented with the gas treatment apparatus of claim 1.
